(19) United States
(12) Patent Application Publication
(10) Pub. No.: US 2024/0090540 A1
(43) Pub. Date: Mar. 21, 2024

(54) FOODSTUFF PRODUCT

(71) Applicant: SOCIETE DES PRODUITS NESTLE S.A., Vevey (CH)

(72) Inventors: MADIAN OTHMAN ABU-HARDAN, Konolfingen (CH); ARISTODIMOS LAZIDIS, York, North Yorkshire (GB); RICARDO ANDRES RODRIGUEZ ROSENDE, Santiago (CL); ANDREW STEVEN WHITEHOUSE, GB-Harrogate, North Yorkshire (GB)

(21) Appl. No.: 18/256,670

(22) PCT Filed: Dec. 10, 2021
(86) PCT No.: PCT/EP2021/085277

§ 371 Date: Jun. 9, 2023

(30) Foreign Application Priority Data
Dec. 11, 2020 (EP) 20213370.8

(51) Int. Cl. A23L 7/126; A23L 29/238

(52) U.S. Cl. CPC A23L 7/126; A23L 29/238

(57) ABSTRACT

The present invention provides new products using mucilaginous seeds as binders.

The present invention relates to the field of new foodstuffs, preferably baked products.

### BACKGROUND

It is a recognised worldwide issue that greater numbers of the population are becoming overweight. It is also becoming apparent that rising numbers of children below 6 years old have obesity.

Implementation of laws or regulations that are aligned with OMS recommendations with the purpose of protect the health of children and avoid the problems mentioned above is a trend in a large number of countries.

For example, Chile started in the year 2016, with the “labelling law” which stablishes limits for calories, sugars, sodium, and saturated fats. Any foodstuff above these limits must be labelled with a warning sign and it is forbidden to have publicity oriented to children. Only foodstuff that contains less sugar, saturated fats and calories than the limits established or that does not have added sugar or saturated fats, is warning sign free.

The addition of sugar comprises sugars like mono and disaccharides, white and brown sugar, syrups (including fruit concentrates) honey and food additives that contains sugars.

Accordingly, it is a challenge to produce feasible foodstuffs that the consumer enjoys but complying with these nutritional regulations and OMS recommendations.

The role of sugar in foodstuffs and in particular bakery products and products using binders is crucial. The omission of this ingredient can lead to problems in processing during manufacture. Additionally, the omission of sugars will have an impact on texture and flavour profile, leading to an un-preferred product.

Specifically, the use of sugar in binders for bakery products is generally considered key in order to achieve the necessary adhesion strength.

Alternatives for sugar replacement in confectionary products have been developed. However, these ingredients are not considered healthy and/or desirable by the consumers due their perceived “chemical” nature or their association with “chemical” ingredients (i.e. polyols, resistant starch, fructooligosaccharides, etc.).

Accordingly, what would be desirable is a consumable that does not contain any added sugars but does not suffer from any problems of manufacture and any loss in consumer enjoyment.

It is known in the art to use mucilaginous seeds as egg replacements in baked goods such as cakes, brownies etc. It is also known to extract gels from these seeds for the above-uses. These uses are typically on the kitchen scale and revolve around the replacement of egg in flour-based products.

The present invention seeks to provide alternative binder solutions for products that can be made using industrial techniques and provide the necessary shelf-stability and product durability for commercial products. Hence, the present invention relates to significantly different products and processes from those known in the art.

The present invention is envisaged with the solving the above problems.

### SUMMARY OF INVENTION

The present invention provides a, preferably baked, foodstuff and a foodstuff composition that is then baked to provide the baked foodstuff.

Specifically, the present invention provides a foodstuff comprising a binder and inclusions, wherein the binder comprises water and mucilaginous seeds and relative to the weight of the composition the binder is present in an amount of between 25.0 wt % and 35.0 wt % and the inclusions between 65.0 wt % and 75.0 wt %, wherein the weight ratio of mucilaginous seeds to water in the binder is between 0.20 and 0.50.

The present invention provides a process for preparing the above foodstuffs and baked foodstuffs, preferably using an extrusion process and baking.

### DETAILED DESCRIPTION

### Foodstuff Product

The present invention provides a foodstuff composition that is preferably baked to provide a mixture of inclusions bound by a binder.

In an embodiment, the present invention relates to foodstuffs formulated to preferably not contain added sugar, specifically not contain added sugar in the binder.

Specifically, the present invention relates to foodstuff comprising a binder and inclusions, wherein the binder comprises water and mucilaginous seeds and relative to the weight of the composition the binder is present in an amount of between 25.0 wt % and 35.0 wt % and the inclusions between 65.0 wt % and 75.0 wt %, wherein the weight ratio of mucilaginous seeds to water in the binder is between 0.20 and 0.50.

In an embodiment, relative to the weight of the composition the binder is present in an amount of between 25.0 wt % and 35.0 wt % and the inclusions between 65.0 wt % and 75.0 wt %.

In a preferred embodiment, the binder is present in an amount of greater than 26.0 wt %, preferably greater than 27.0 wt % and most preferably greater than 28.0 wt %.

In a preferred embodiment, the binder is present in an amount of less than 34.0 wt %, preferably less than 33.0 wt % and most preferably less than 32.0 wt %.

In a preferred embodiment, the inclusions are present in an amount of greater than 66.0 wt %, preferably greater than 67.0 wt % and most preferably greater than 68.0 wt %.

In a preferred embodiment, the inclusions are present in an amount of less than 74.0 wt %, preferably less than 72.0 wt % and most preferably less than 72.0 wt %.

In a preferred embodiment, relative to the weight of the composition the binder is present in an amount of between 26.0 wt % and 34.0 wt % and the inclusions between 66.0 wt % and 74.0 wt %.

In a preferred embodiment, relative to the weight of the composition the binder is present in an amount of between 28.0 wt % and 32.0 wt % and the inclusions between 68.0 wt % and 72.0 wt %.

The foodstuff of the present invention is preferably baked so that the binder is baked to increase adhesion of the inclusions to each other.

Baked foodstuffs used in the invention may be sweet or savoury. In an embodiment, the baked foodstuff may comprise a coating or a filing or both.

In an embodiment, the foodstuff does not comprise inclusions in the form of a flour or a powder or is substantially free of inclusions in the form of a flour or a powder.

The present invention preferably relates to binding inclusions of a significant size.

In a preferred embodiment, the inclusions are either whole or only partially broken.

In a preferred embodiment, a flour or powder is defined as a composition with an average particle size of between 0.1 mm and 2.0 mm, 0.5 mm and 2.0 mm, or between 0.1 and 0.5 mm.

In a preferred embodiment, no significant amount of flour or powder is added to any component of the present invention. In an embodiment, the foodstuff comprises flour or powder between 0.0 wt % and 1.0 wt %, preferably between 0.0 wt % and 0.25 wt %, preferably between 0.00 wt % and 0.004 wt %, and most preferably 0.0 wt %, more preferably 0.00 wt % or 0.000 wt %.

In an embodiment, the binder used in the foodstuff does not comprise added sugar or is substantially free of added sugar.

In the present invention, the terms “added sugar”, “intrinsic sugar”, “natural sugar” and alike have their standard meanings in the art. In line with the recognised meaning in the art, naturally occurring sugars are found naturally in foods such as fruit (fructose) and milk (lactose). Added sugars are sugars and syrups put in foods during preparation or processing.

For example, the US FDA have defined added sugars as: “sugars that are either added during the processing of foods, or are packaged as such, and include sugars (free, mono and disaccharides), syrups, naturally occurring sugars that are isolated from a whole food and concentrated so that sugar is the primary component (e.g., fruit juice concentrates), and other caloric sweeteners. This would include single ingredient foods such as individually packaged table sugar. Sugar alcohols are not considered to be added sugars.

Names for added sugars include: Brown sugar, corn sweetener, corn syrup, dextrose, fructose, fruit juice concentrates, glucose, high-fructose corn syrup, honey, invert sugar, lactose, maltose, malt sugar, molasses, raw sugar, turbinado sugar, trehalose, and sucrose”.

Preferably, as recited in Regulation (EC) No 1924/2006, the present invention relates to foodstuffs where sugars have not been added and the product does not contain any added mono- or disaccharides or any other food used for its sweetening properties other than sugars that are inherently naturally present in the ingredients.

In an embodiment, the baked foodstuff only comprises sugar that is intrinsic to ingredients present. In an embodiment, there is no added sugar, for example there are no added mono and disaccharides, white and brown sugar, syrups (including fruit concentrates, e.g. fruit- or plant-based syrups), honey and food additives that contain sugars.

In a preferred embodiment, no significant amount of additional sugar is added to any component of the present invention, i.e. there is no additive that may be considered a sugar. In an embodiment, the foodstuff comprises an added sugar between 0.0 wt % and 1.0 wt %, preferably between 0.0 wt % and 0.25 wt %, preferably between 0.00 wt % and 0.004 wt %, and most preferably 0.0 wt %, more preferably 0.00 wt % or 0.000 wt %.

In a preferred embodiment, the foodstuff contains less than 100 ppm, preferably less than 50 ppm, preferably less than 25 ppm, and most preferably 0 ppm of an added sugar.

In a preferred embodiment of the present invention, the baked foodstuff post-baking, has a total moisture content of less than 10.0 wt % based on the weight of the foodstuff, preferably less than 8.0 wt %, preferably less than 7.5 wt %, preferably less than 5.0 wt % and preferably less than 3.0 wt %. In a preferred embodiment, the moisture content is greater than 0.25 wt % or greater than 0.50 wt %. In a preferred embodiment, the moisture content of the foodstuff, preferably baked foodstuff, is between 0.25 and 10.0 wt %. Any suitable method for measuring this moisture content is applicable, for instance, by thermogravimetric analysis, e.g. using a drying oven and calculating a loss on drying, or using an infra-red moisture analyser.

### Binder

In an embodiment, the binder used in the present invention is a combination of water and mucilaginous seeds.

In a preferred embodiment, the mucilaginous seeds are selected from chia, flax, cress, rucola, mustard, basil, arugula and combinations thereof, most preferably chia and/or flax seeds.

In a preferred embodiment, the weight ratio of mucilaginous seeds to water in the binder is between 0.20 and 0.50.

In a preferred embodiment, the weight ratio is greater than 0.22, preferably greater than 0.25, preferably greater than 0.275, more preferably greater than 0.28, and most preferably greater than 0.29.

In a preferred embodiment, the weight ratio is less than 0.45, preferably less than 0.40, preferably less than 0.375, more preferably less than 0.36 and most preferably less than 0.35.

Hence, preferred embodiments of the invention weight ratio of mucilaginous seeds to water in the binder is between 0.22 and 0.45, preferably between 0.25 and 0.40, more preferably between 0.275 and 0.375 and more preferably between 0.28 and 0.36.

In an embodiment, the seeds are present in whole form (i.e. are not ground, milled, etc.). In an alternative embodiment, the seeds are ground, preferably in the form of meal.

In an embodiment, the binder is prepared by a process comprising the step of mixing mucilaginous seeds with water for a time period of greater than 5 minutes at a temperature of between 15.0° C. and 35° C. (water temperature) to form a binder.

In a preferred embodiment, the mixing time is between 10 minutes and 1 hour, preferably between 15 minutes and 45 minutes.

In a preferred embodiment, the temperature is between 20° C. and 30° C., preferably between 20° C. and 25° C.

In a preferred embodiment, the binder has a work of adhesion of between −50 and −350 g·sec., preferably between −75 and −300 g·sec., and more preferably between −100 and −275 g·sec.

In an embodiment, the binder may comprise additional ingredients.

In an embodiment, these ingredients may be sugar (preferably mono- or di-saccharides, preferably sucrose) and/or protein (preferably whey protein).

In a preferred embodiment, the binder does not contain additional ingredients that significantly absorb water.

In a preferred embodiment, the additional ingredients do not absorb more than 20.0 wt % water based on the weight of the additional ingredients when held in the binder solution for 20 minutes, preferably do not absorb more than 15.0 wt % and more preferably do not absorb more than 10.0 wt % water. Preferably, this is assessed by weighing the additional ingredients prior and post to holding in the binder solution.

In a preferred embodiment, the binder does not contain starch, fibres, polysaccharides (for example, galacto-oligosaccharides, fructo-oligosaccharides, cellulose etc.), flours (for example, cereals, nuts, seeds etc.) and combinations thereof.

If additional ingredients are present, in a preferred embodiment, the binder comprises additional ingredients in an amount between 0.0 wt % and 30.0 wt %, preferably between 1.0 wt % and 25.0 wt %, preferably between 2.0 wt % and 20.0 wt %, and preferably 3.0 wt % and 15.0 wt %.

In a preferred embodiment, the binder substantially consists of the seeds and water. In a preferred embodiment, this means that the binder only contains seeds and water, preferably the weight percentage of seeds and water totals 100% of the binder weight.

### Inclusions

The foodstuff of the invention comprises inclusions. The term “inclusions” is well known in the art of food chemistry, preferably meaning small format food ingredients formulated to deliver functional properties, including taste, texture, aroma and eye appeal both in and on finished food products.

The inclusions may be any that are commonly used in the art, like fruit-based inclusions, nut-based inclusions, seed-based inclusions, cereal-based inclusions, fat-based inclusions (e.g. chocolate- or compound-) and yogurt-based inclusions, for example. The inclusions may take the form of those commonly used, for example whole grain, chips, flakes, grains, crisps/crispies etc. and combinations thereof.

In an embodiment, the inclusions may comprise cereal-based inclusions, preferably oats, wheat, barley (preferably oat flakes), rice, maize, quinoa, etc. and combinations thereof.

In an embodiment of the present invention, the inclusions comprises a nut or culinary nut (preferably chestnuts, hazelnuts, Brazilian nut, almond, peanut, cashew nut, pistachio, pili, pecan, pine, hazel nut or combinations thereof) and/or a seed (preferably sunflower, rapeseed, sesame, flaxseed, hemp seed, linseed, pumpkin or combinations thereof).

In an embodiment, where seeds are present as inclusions, these amounts are not to be taken as contributing to the binder composition.

In a preferred embodiment, the inclusions have a particle size greater than 1.0 mm, preferably greater than 1.5 mm, preferably greater than 2.0 mm. In a preferred embodiment, the inclusions have a particle size lower than 30.0 mm, preferably lower than 25.0 mm and preferably lower than 20.0 mm.

In a preferred embodiment, the particle size is between 1.0 mm and 30.0 mm, preferably between 1.5 mm and 25.0 mm and more preferably between 2.0 mm and 20.0 mm.

In a preferred embodiment, the particle size is defined using mesh sizes, i.e. the particle is placed on a mesh of defined sizes and if the particle falls through at the preferred lower limit it is not within the present invention and if the particle does not fall through at the preferred upper limit it is not within the present invention.

For example, for the range of 1.0 mm to 30.0 mm, particles that fall through a square mesh of 1.0 mm hole-side dimension and do not fall through a mesh of 30.0 mm hole-side dimension are not within the range claimed.

In a preferred embodiment, the inclusions do not absorb a significant amount of water from the binder and/or are not present in significant amounts.

In a preferred embodiment, the inclusions do not absorb more than 20.0 wt % water based on the weight of the inclusion when held in the binder solution for 20 minutes, preferably do not absorb more than 15.0 wt % and more preferably do not absorb more than 10.0 wt % water. Preferably, this is assessed by weighing the inclusions prior and post to holding in the bind solution.

In a preferred embodiment, if the inclusions comprise puffed or extruded products (e.g. rice crispies) in an amount of less than 40.0 wt %, preferably less than 37.5 wt %, and preferably less than or equal to 35.0 wt %.

In order to improve processability and adhesion and ensure the optimum organoleptic properties, the amount of puffed or extruded products in a preferred embodiment are present in an amount of less than 20.0 wt % or preferably less than 17.5 wt %.

The absorption of water leads to products that are extremely sticky and hard to bite. The doughs are very wet and with a plastic behaviour. Additionally, this produced doughs that could not be processed using industrial techniques, e.g. rotary moulding and extrusion. Furthermore, the inclusions may be damaged using the rotary moulding process.

Hence, whilst certain compositions within the present invention can be rotary moulded, in a highly preferred embodiment, the compositions of the present invention are processed using extrusion, preferably wire cutting.

Accordingly, these findings are in contrary to the known uses of mucilaginous seeds. The known methods tend to use highly absorbent and/or flour/powder-based ingredients to prepare often hand-made products. The present invention provides alternative products using significantly different production techniques to the previously known uses of mucilaginous seeds.

Additionally, the present invention provides these advantages without the use of sugar in certain embodiments.

### Additional Ingredients

The cellular structure of the foodstuff can be further strengthened using known stabilisers such as starch, modified starch, gums such as locust bean gum, guar gum, gum acacia, tragacanth, xanthan, karaya, gellan, tars, cellulose and cellulose derivatives, pectin or gelatin, maltodextrins, gelling agents such as alginates or carageenan, proteins or protein sources such as albumins, casein, caseinates, milk powders or whey powders.

In an embodiment of the present invention, the high intensity sweetener is a natural component, for example, a Luo Han Guo fruit extract (mogrosides), a steviol glycoside and combinations thereof. In an embodiment, the, preferably baked, foodstuff may comprise steviol glycosides selected from rebaudioside A, B, C, D, E, M and X and stevioside and combinations thereof. In a preferred embodiment, rebaudioside A, B or mixtures thereof is present.

The foodstuff of the present invention may include functional ingredients, for example, anti-oxidants, vitamins, probiotics, prebiotics and/or minerals.

In an embodiment, the present invention may also comprise polyols, for example, polyols may comprises sorbitol, xylitol, maltitol and lactitol or combinations thereof.

However, in an alternative embodiment, polyols are not present, i.e. at preferably 0.00 wt % or 0.000 wt % of the foodstuff.

Usefully the total amount of other ingredients (e.g. ingredients that are not binder or inclusions) in the, preferably baked, foodstuff is no more than 20%, no more than 15% or no more than 10% by weight of the, preferably baked, foodstuff, preferably no more than 8.5%, no more than 5.0%, no more than 2.5%, no more than 1.0% and most preferably 0%.

In a preferred embodiment, the total amount of other ingredients is greater than 2.5% by weight of the foodstuff, preferably greater than 5.0 wt %.

### Production Process

In an embodiment of the present invention, the baked foodstuffs are prepared by a process that comprises the steps of mixing, forming and baking. Dough can be formed or moulded using rotary moulded, lamination or extrusion equipment (e.g. wire cutting), preferably rotary moulding (preferably small scale, i.e. non-industrial scale) or extrusion equipment.

In a preferred embodiment, the forming is carried out using extrusion equipment.

In an embodiment, the baking temperature is between 100 and 220° C., between 120 and 200° C., between 130 and 190° C. or between 140 and 180° C.

In an embodiment, the baking time is between 5 and 30 minutes, between 6 and 20 minutes, between 7 and 15 minutes or between 8 and 12 minutes.

In a preferred embodiment, the baking step is carried out between 130 and 190° C. and between 7 and 15 minutes.

In an embodiment of the present invention, the baking step comprises one or more stages. In an embodiment, the temperature of both stages is in the above ranges but may be different. The combined time period for both stages is preferably within the above ranges.

In a preferred embodiment, the humidity of the baking step is within the range of 20% to 60%, preferably 30% to 50%.

The present invention provides a process for preparing a baked foodstuff comprising the steps of:
mixing mucilaginous seeds with water for a time period of greater than 5 minutes at a temperature of between 15.0° C. and 35° C. to form a binder,
combining the binder with the inclusions in an amount of between 25.0 wt % and 35.0 wt % and the inclusions between 65.0 wt % and 75.0 wt %,
moulding the mixture of binder and inclusions using either rotary moulding or extrusion, and
baking at a temperature between 100 and 220° C. for between 5 and 30 minutes.

In a highly preferred embodiment, the present invention utilises extrusion, preferably wire cutting. This process feature enables demoulding without a reduction in the integrity of the inclusions.

### Definitions

Preferably, in all ranges defined above, the end points are included within the scope of the range as written. Additionally, the end points of the broadest ranges in an embodiment and the end points of the narrower ranges may be combined.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

The term “substantially” as used herein may refer to a quantity or entity to imply a large amount or proportion thereof. Where it is relevant in the context in which it is used “substantially” can be understood to mean quantitatively (in relation to whatever quantity or entity to which it refers in the context of the description) there comprises a proportion of at least 80%, preferably at least 85%, more preferably at least 90%, most preferably at least 95%, especially at least 98%, for example about 100% of the relevant whole. By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole. Preferably, where appropriate (for example in amounts of ingredient) such percentages are by weight.

Unless otherwise specified, the percentages listed are by weight.

The present invention is further described by reference to the non-limiting specific examples.

### EXAMPLES

The present invention will be now be exemplified with the following specific examples.

All examples are prepared on a wt % basis.

The baking after moulding/extrusion was carried out at 40% Humidity in the oven, 150° C. for 6 minutes first and then 170° C. for 4 minutes unless otherwise specified.

Rice/corn blend are puffed cereals (i.e. crispies) used as inclusions.

The rice/corn blend had particle sizes from 2.0-4.0 mm and the pumpkin seed from 8.0-13.0 mm as measured using meshes of corresponding sizes. The other inclusions used had sizes between these two extremes.

### Binders

Eight different tubes were prepared only with water and chia seeds. The ingredients were mixed (water was at 21° C.) and left to rest for 20 minutes. After that work of adhesion and stickiness of the mixture was measured using a texture analyser (TA XT PLUSC www.stablemicrosystems.com/TAXTplus.html).

| Binder | 1 | 2 | 3 | 4 | 5 | 6 | 7 | 8 |
|---|---|---|---|---|---|---|---|---|
| Chia seeds (g) | 1.5 | 4.5 | 7.5 | 10.5 | 13.5 | 16.5 | 19.5 | 22.5 |
| Water (g) | 28.5 | 25.5 | 22.5 | 19.5 | 16.5 | 13.5 | 10.5 | 7.5 |
| Chia/water ratio | 0.05 | 0.18 | 0.33 | 0.54 | 0.82 | 1.22 | 1.86 | 3 |
| Work of adhesion/g · sec. | −2.39 | −65.31 | −244.89 | −129.73 | −124.11 | −57.18 | −38.96 | NA |
| Stickiness N | −0.21 | −1.67 | −6.19 | −13.85 | −15.14 | −8.59 | −5.27 | −0.03 |

### Comparative Example 1

The binder recipe using a ratio between chia seeds and water of 0.33 w/w was selected. We fixed the amount of binder at 24 wt %. We mixed the water with the chia (21° C.) and letting them rest for 20 minutes. The binder was then mixed with the rest of the ingredients with a resting time of 5 minutes. After that, biscuits were moulded in a rotary moulding machine. Comparative Example 1 did not attach properly to the forcing roll and no biscuits were obtained.

| Recipe | % | Weight/g |
|---|---|---|
| Chia seeds | 6 | 30 |
| Water | 18 | 90 |
| Rice/corn blend | 35 | 175 |
| Roasted pumpkin seed | 28 | 140 |
| Oat Flakes | 13 | 65 |
| Total | 100 | 500 |

Hence, binder amounts outside of the lower limit of the present invention are not capable of forming products.

### Comparative Example 2 and Examples 1 and 2

We increased the amount of binder to 30% and kept the procedure of mixing (water temperature was constant=21° C.) (Example 1). Contrary to the previous trial, an improvement in adhesion was observed and processability improved. In a different trial we increased the amount of binder to 35% and a significant change in consistency was observed. The dough behaved like a gum and only 4 biscuits were able to demould (Example 2).

We even increased the percentage of binder to 40% obtaining even worse results; no biscuits were obtained (Comparative Example 2).

| Recipe (Example 1) | % | Weight/g |
|---|---|---|
| Chia seeds | 7.5 | 37.5 |
| Water | 22.5 | 112.5 |
| Rice/corn blend | 32.2 | 161.2 |
| Roasted pumpkin seed | 25.8 | 129.0 |
| Oat Flakes | 12.0 | 59.9 |
| Total | 100 | 500 |

Hence, binder amounts outside of the upper limit of the present invention are not capable of forming products.

### Comparative Example 3

We increased the amount of chia in the recipe and therefore its ratio with water (0.54 w/w) keeping the amount of binder (24%). The mix had very poor adhesion to the forcing roll. No biscuits were obtained.

| Recipe (Comparative Example 3) | % | Weight/g |
|---|---|---|
| Chia seeds | 8.4 | 42.0 |
| Water | 15.6 | 78.0 |
| Rice/corn blend | 35.0 | 175.0 |
| Roasted pumpkin seed | 28.0 | 140.0 |
| Oat Flakes | 13.0 | 65.0 |
| Total | 100 | 500 |

Hence, binder compositions outside of the limits of the present invention are not capable of forming products.

### Example 3

| Recipe (Example 3) | % | Weight/g |
|---|---|---|
| Chia seeds | 6.0 | 30 |
| Water | 18.0 | 90 |
| Peanuts | 76.0 | 380 |

The amount and composition binder afforded improved processability along with the adhesion of the mix.

### Example 4

| Recipe (Example 4) | % | Weight/kg |
|---|---|---|
| Chia seeds | 7.5 | 4.9 |
| Water | 22.5 | 14.6 |
| Almond | 12.6 | 8.2 |
| Roasted pumpkin seed | 20.0 | 11.7 |
| Oat Flakes | 19.0 | 12.4 |
| Chocolate compound chips | 18.0 | 11.7 |
| Total | 100 | 65 |

The above recipe was tested in an industrial rotary mould machine, which lead to inclusions being crushed and demoulding was not consistent. However dough was taken from the same batch and passed through a manual extruder. The pieces were cut by using a wire and baked. Advantageously, the dough and the biscuit hold together before and after the baking, respectively.

### Examples 5 and 6

| | Example 5/% | Example 6/% |
|---|---|---|
| Chia seeds | 7.5 | 7.5 |
| Water | 22.5 | 22.5 |
| Almond | 22.0 | 22.0 |
| Roasted pumpkin seed | 10.0 | 10.0 |
| Oat Flakes | 20.0 | 10.0 |
| Chocolate compound chips | 18.0 | |
| Cranberry pieces (dehydrated) | | 10.0 |
| Banana pieces (dehydrated) | | 10.0 |
| Total | 100 | 100 |

The above recipes were prepared using the manual wire-cut apparatus used earlier.

Products made in Example 5 contained between 2.0 and 3.5 wt % water (drying oven loss on drying). The dough of Example 6 was slightly stickier than Example 5. However, both examples provided products that could be moulded and baked with a retention of integrity.

### Example 7 and Comparative Example 4

Comparative Example 3 was repeated with the following modifications:

| Recipe (Example 7) | % | Weight/g |
|---|---|---|
| Chia seeds | 4.8 | 24.0 |
| Water | 14.4 | 72.0 |
| Sugar | 4.8 | 24.0 |
| Rice/corn blend | 35.0 | 175.0 |
| Roasted pumpkin seed | 28.0 | 140.0 |
| Oat Flakes | 13.0 | 65.0 |
| Total | 100 | 500 |

| Recipe (Comparative Example 4) | % | Weight/g |
|---|---|---|
| Chia seeds | 4.8 | 24.0 |
| Water | 14.4 | 72.0 |
| Starch | 4.8 | 24.0 |
| Rice/corn blend | 35.0 | 175.0 |
| Roasted pumpkin seed | 28.0 | 140.0 |
| Oat Flakes | 13.0 | 65.0 |
| Total | 100 | 500 |

Addition of 4.8% of sugar and starch in the binder was tested to ascertain if improvement in that stickiness and work of adhesion as measured using a texture analyser (data not shown) could correlate with improved products. The amount of binder was kept the same. Adhesion was improved with the recipe with sugar and biscuits were obtained. Contrary, starch dried the dough quickly and deagglomeration was observed (no biscuits were obtained).

### Comparative Examples 5 and 6

Flax seeds and chia seeds were separately mixed with water at a ratio of 0.20 under the above conditions. A 35 g portion was taken and mixed with 5 g of inulin.

125 g of assorted dried fruit and nuts were mixed with 35 g of binder alone and the 40 g binder including inulin (i.e. 22.0% and 24.2% binder). The samples were hand-formed into biscuit sized products.

After baking over various periods up to 50 minutes at 100° C. the products were not structurally solid and were too soft to be used industrially.

### Example 8

Examples 5 and 6 using an industrial wire cut device. The cutting frequency was 30 cuts/min and a nozzle of 55 mm. The biscuits were consistent and well-formed.

1. A foodstuff composition comprising a binder and inclusions, wherein the binder comprises water and mucilaginous seeds and relative to the weight of the composition the binder is present in an amount of between 25.0 wt % and 35.0 wt % and the inclusions between 65.0 wt % and 75.0 wt %, wherein the weight ratio of mucilaginous seeds to water in the binder is between 0.20 and 0.50.

2. The foodstuff composition of claim 1, wherein the mucilaginous seeds are selected from the group consisting of chia, flax, cress, rucola, mustard, basil, arugula and combinations thereof, most preferably chia and flax seeds.

3. The foodstuff composition of claim 1, wherein the inclusions are selected from the group consisting of fruit-based inclusions, seed-based inclusions, chocolate-based inclusions, nut-based inclusions, cereal-based inclusions and yogurt-based inclusions and combinations thereof.

4. The foodstuff of claim 1, wherein the inclusions do not absorb more than 20.0 wt % water based on the weight of the inclusion when held in the binder solution for 20 minutes.

5. A process for preparing a composition comprising the step of mixing mucilaginous seeds selected from the group consisting of chia, flax, cress, rucola, mustard, basil, arugula and combinations with water for a time period of greater than 5 minutes at a temperature of between 15.0° C. and 35° C. to form a binder, wherein the binder comprises water and mucilaginous seeds and relative to the weight of the composition the binder is present in an amount of between 25.0 wt % and 35.0 wt % and the inclusions between 65.0 wt % and 75.0 wt %, wherein the weight ratio of mucilaginous seeds to water in the binder is between 0.20 and 0.50.

6. The process of claim 5, wherein the mixing time is between 10 minutes and 1 hour.

7. The process of claim 5, wherein the temperature is between 20° C. and 30° C.

8. The process of claim 5, comprising combining the binder with the inclusions.

9. The process of claim 5, comprising moulding or forming the mixture of binder and inclusions.

10-14. (canceled)
